(19) United States
(12) Patent Application Publication
(10) Pub. No.: US 2003/0055717 A1
(43) Pub. Date: Mar. 20, 2003

(54) Promotion system and method

(76) Inventors: Ujwal Rao Badugu, Plano, TX (US); Srikantappa Ravi Kumar, Addison, TX (US); Shriram K. Subramanian, Dallas, TX (US); Jerry Gene Wood, Denton, TX (US)

Correspondence Address: HAYNES AND BOONE, LLP, 901 MAIN STREET, SUITE 3100, DALLAS, TX, 75202, US

(21) Appl. No.: 09/860,407

(22) Filed: May 18, 2001

(51) Int. Cl. G06F 17/60

(52) U.S. Cl. 705/11

(57) ABSTRACT

A system and method is provided for automatically promoting a representative in a network marketing organization which includes multiple career levels. The representative is associated with account information. The system accepts application information and updates the account information. The system retrieves a plurality of promotion parameters and the updated account information and applies the promotion parameters to the account information to determine if the representative qualifies for a promotion. If the representative qualifies for a promotion, the system automatically updates the representative's career level with a new career level.

### BACKGROUND

This invention relates generally to network marketing and, more specifically, to a system and method for promoting and/or rewarding individuals in a network marketing type organization.

Promoting individuals is an established method of rewarding those who have achieved certain levels of success within an organization. A promotion not only rewards the individual being promoted, but serves as a positive reinforcement to others. The organization typically defines one or more qualifications for achieving a certain promotion level. The actual qualifications for promotion may range from the simple to the complex, depending on the type of organization and the specific types of behavior which a particular organization wishes to encourage.

The difficulty, particularly in large organizations and those with complex promotional requirements, is to recognize when a certain individual is ready for a promotion. Ensuring that the individual is qualified may take time and, if mistakes are made, may result in unnecessary delay as the mistakes are corrected. This delay may diminish any positive reinforcement that the organization wishes to promote and is therefore undesirable. In addition, if an individual is incorrectly promoted, a demotion to rectify the situation may demoralize others in the organization.

Therefore, what is needed is an improved method of recognizing when an individual within an organization has the qualifications for a promotion and automatically promoting that individual in a timely manner.

### SUMMARY

A system and method is provided for automatically promoting an individual, or “representative,” in an organization having multiple career levels. The representative is associated with account information including a current career level and a downline. In one embodiment, the system provides a representative entry system, a communications interface accessible to the representative entry system, a database, and software. The database, which is accessible to the representative entry system through the communications interface, includes the current career level, the downline, and a plurality of promotion parameters defining at least one qualification necessary for promotion to each of the plurality of career levels.

The software, which is capable of interacting with the database, is operable for accepting application information for a second representative associated with the first representative, and updating the account information to reflect the application information. The software is also operable for entering the first representative in a queue by notifying the system that the first representative may qualify for a promotion, and de-queueing the first representative from the queue. In some embodiments, the software is further operable for retrieving the plurality of promotion parameters and the updated account information from the database.

In operation, the software applies a first promotion parameter to the updated account information to identify a highest career level for which the first representative is qualified, compares the highest career level to the current career level of the first representative, and compares the downline to a second promotion parameter. The software can thereby automatically promote the first representative if the highest career level is greater than the current career level and the downline satisfies the second promotion parameter. The software also updates the current career level in the database with the highest career level if a promotion occurs.

In another embodiment, the system includes a customer entry system and a second communications interface accessible to the customer entry system. The database is accessible to the customer entry system through the second communications interface. The software in this embodiment is operable for retrieving a customer count associated with the account information and comparing the customer count to a third promotion parameter. In this way, the representative is not promoted unless the customer count satisfies the third promotion parameter.

In still another embodiment, the system includes software operable for retrieving at least one customer point associated with the account information and comparing the at least one customer point to a fourth promotion parameter, wherein the representative is not promoted unless the at least one customer point satisfies the fourth promotion parameter.

### BRIEF DESCRIPTION OF THE DRAWINGS

FIG. 1a is a schematic diagram illustrating the nature of a network marketing organization.

FIG. 1b is a diagram illustrating a relationship between system components through which a real time promotion process of the present invention may be implemented and the components relationship to the promotion process.

FIG. 2 is a schematic diagram of a network of computers that may be utilized for implementing the promotion system of the present invention.

FIG. 3 is a diagram illustrating a system architecture, operable on the computer network of FIG. 2, for implementing the promotion system of the present invention.

FIG. 4 is an object diagram illustrating object relationships in the system architecture of FIG. 3.

FIG. 5 is an object diagram illustrating objects identifying a representative in the system architecture of FIG. 3.

FIG. 6 is an object diagram illustrating processes for manipulating aspects of the representative of FIG. 5.

FIG. 7 is a chart illustrating a promotion path for a representative in the system architecture of FIG. 3.

FIG. 8 is a diagram illustrating the flow of information in the system of FIG. 1 following the submission of a customer application.

FIG. 9 is a diagram illustrating the flow of information in the system of FIG. 1 following the submission of a representative application.

FIG. 10 is a diagram illustrating the flow of information from the application submissions of FIGS. 8 and 9 through the real time promotion process.

FIG. 11 is a flow chart illustrating the real time promotion process of FIG. 1 operable to promote a representative along the promotion path of FIG. 7.

FIG. 12 is a flow chart detailing a specific step of FIG. 11.

FIGS. 13a-13b are flow charts detailing a specific step of FIG. 11.

### DETAILED DESCRIPTION

The present disclosure relates to a promotion system and method, such as can be used in a marketing plan of an organization having multiple career levels. Specific examples of components and arrangements are described below to simplify the present disclosure. These are, of course, merely examples and are not intended to limit the invention as set forth in the attached claims. In addition, the present disclosure may repeat reference numerals and/or letters in the various examples. This repetition is for the purpose of simplicity and clarity and does not in itself dictate a relationship between the various embodiments and/or configurations discussed.

Referring now to FIG. 1a, one organizational structure which may benefit from the present invention is illustrated as an exemplary business environment. A company 30 utilizes a network marketing plan to implement a network marketing organization 32. The organization 32 provides a vertical structure of multiple levels which rewards a representative for obtaining customers and recruiting additional representatives. A representative is an individual who represents the organization, and may be an independent contractor (hereinafter referred to as an independent representative, or “IR”) or an employee of the company 30. The customer is an entity that provides a source of revenue for the company by purchasing the products or services through their representative.

In the present example, a representative 34 has obtained customers 36, 38 and recruited additional representatives 40, 42. The representative 34 is the “sponsor” of the representatives 40, 42, which means that the representative brought them into the organization. The organization 32 may have a plurality of representatives 54 and 56, each with his or her own customers and representatives (not shown).

The customers 36, 38 and representatives 40, 42 are part of a “downline” for the representative 34. A downline identifies customers and representatives who are brought into the organization 32 by the representative. Additionally, the downline may extend through multiple levels of representatives and customers. In the present example, the downline of the representative 34 also includes the customers 44, 48, 50 and 52, as well as the representatives 40, 42 and 46. The representative 34 is compensated for revenue generated for the company from the downline, as well as for bringing new representatives into the company. The representative 34 receives “back-end” commissions for the customer generated revenue and “front-end” commissions for recruiting new representatives and helping them get started. As the representative 34's downline grows, the representative 34 receives more compensation, which encourages the representative 34 to actively seek new customers and new representatives.

Similarly, each representatives that are in the downline of another (higher) representative may have their own downline. In the present example, the downline of the representative 40 includes the customer 44, while the downline of the representative 42 includes the representative 46 and the customers 48, 50 and 52. Therefore, the downline of the representative 34 may include a combination of multiple downlines of other lower-level representatives. However, the lower level representatives may not earn as much revenue, since their downlines are not as large. For instance, the compensation earned by the representative 40 may be based only on the revenue generated by the customer 44. A downline representative may also have an “upline,” which includes the representative and the organization directly above the representative.

The company 30 may limit the amount of compensation received by one or more representatives. For example, the company 30 may restrict the compensation received by the representative 34 to a particular number of downline “levels.” For instance, the representative 34 has built a downline that is three levels deep. However, the representative 34 may be limited to compensation for the revenue earned from levels one and two. Revenue generated by the level three customers 50 and 52, therefore, will not count toward the compensation of the representative 34. Additionally, the representative 34 may lose compensation earned through the representatives 40 and 42 from their customers 44, 48, 50 and 52 if the representatives 40 and 42 achieve promotions to the same level as the representative 34.

Therefore, one goal of the company 30 is to encourage the representative 34 to continually seek more customers and recruit more representatives to offset the loss of compensation. This encouragement is partially accomplished by promoting the representative 34 as predetermined levels of achievement are reached. An automatic promotion system, such as that described below, may be implemented to monitor the progress of the representative 34 and promote the representative in real time.

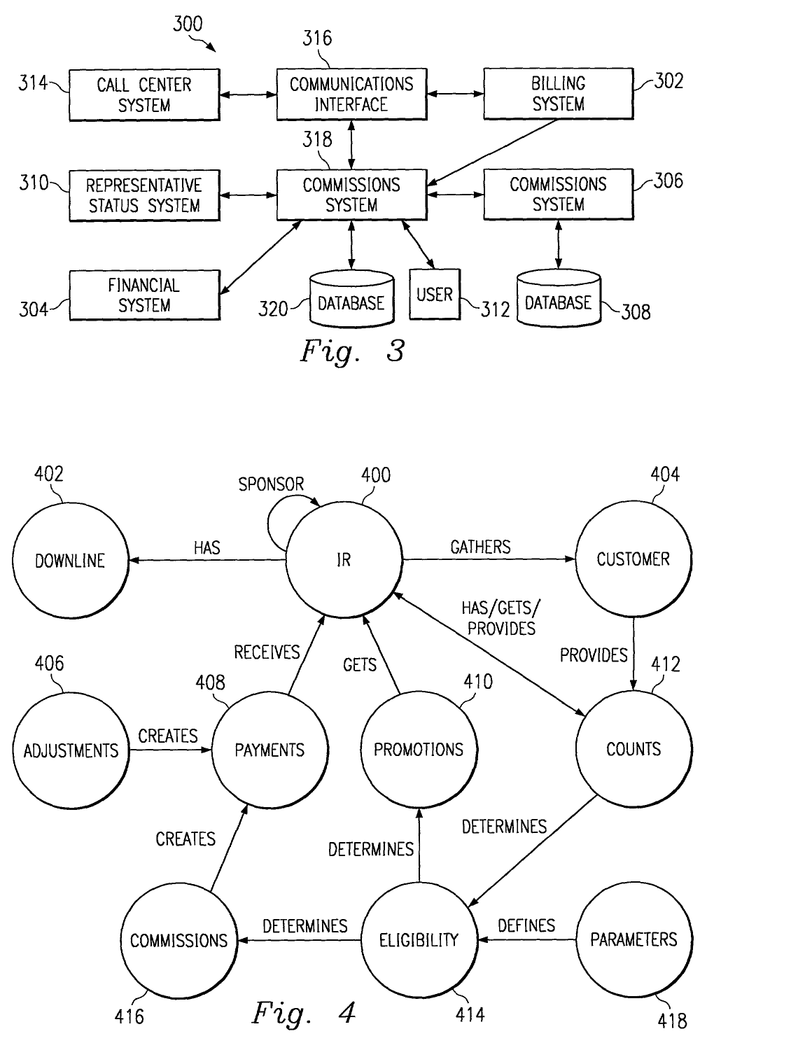

Referring now to FIG. 1b, in one embodiment, a computer system for automatically promoting a representative in real time in a marketing plan, such as that of FIG. 1a, includes a first representative entry system 100 associated with a communications interface 106, a second representative entry system 104, a customer entry system 102 associated with a communications interface 108, and a database 110. The first representative entry system 100 and the customer entry system 102 interact with the database 110 through the communications interfaces 106, 108, respectively. The communications interfaces 106, 108 serve to format the entered information for the database 110. The second representative entry system 104 is operable to interact with the database 110 without a communications interface. The first representative entry system 100 and the customer entry system 102 may be utilized by new customers and new representatives submitting “applications,” while the second representative entry system 104 may be utilized by an existing representative who wishes to submit applications for new representatives. An application may be a request to become a customer or to obtain a product and/or service. It is noted that the entry systems 100-104 may be combined into a single system, may interact with different databases directly or through one or more communications interfaces, or may be arranged in other ways. The relationships between these and other components, as well as the flow of information within the system, will be described in greater detail in reference to FIGS. 3 and 8-10.

Account information, such as a current career level, the number of the representative's customers (customer count), the number of points earned by the representative for each customer, including any products/services which they have purchased (points), and a downline (i.e., other representatives and customers directly or indirectly recruited by the representative) are associated with the representative and stored in the database 110. Also stored in the database is a set of promotion parameters, which may include a set of career levels, the customer count and points that are needed to achieve each career level, the number of levels in the representative's downline, and information detailing each downline level, such as the number of representatives per level. The promotion parameters may be reduced or expanded, depending on the criteria desired for promotions.

Software present on the computer system is operable to automatically promote the representative as follows. Information regarding the representative (DATA 1) or customer (DATA 2) may entered into the first representative entry system 100 or the customer entry system 102. Alternatively, the representative information may be entered into the second representative entry system 104 (DATA 3). The information entered into the second representative entry system 104 is properly formatted for the database 110. The information entered into the first representative entry system 100 and the customer entry system 104 must pass through the communications interfaces 106, 108, to become formatted information DATA 3 and DATA 4, respectively. The formatted information DATA 3, DATA 4 may then be stored in the database 110.

The entry of the customer/representative information into the database 110 is placed into a queue (not shown). Placing the entry into the queue serves as an event in step 112 that notifies the system that information regarding the customer or representative has been queued and may need processing. The event in step 112 may be the addition of a customer or representative, or may be a change in the information representing a customer or representative. For instance, the representative's downline may have increased because a customer was added, and that information may need to be processed. In step 114, the information DATA 4 or DATA 3 relating to the customer or representative, respectively, is retrieved. If the information needs to be updated, the information is processed and the updated information is stored in the database. Storing the updated information in the database 110 also places the representative in a representative queue (not shown), which serves as a triggering event that notifies the system that the representative associated with the updated information may be qualified for a promotion.

When the triggering event occurs, the promotion parameters are retrieved from the database 110 in step 116. In step 118, the customer count, the representative's downline, career level, and any applicable points are retrieved.

The promotion parameters are applied to the representative's information to determine a highest career level for which the representative qualifies and the highest career level is compared to the representative's current career level in step 120. If the highest career level is higher than the current career level, the representative's customer count is compared to the promotion parameter detailing the qualifying customer count for the applicable career level in step 122. If the customer count is greater than or equal to the promotion parameter, the customer/product points are compared to the promotion parameter detailing the qualifying customer/product points for the applicable career level in step 124. If the customer/product points are greater than or equal to the promotion parameter, the downline is compared to the promotion parameter detailing the qualifying downline for the applicable career level in step 126. If the downline meets or exceeds the promotion parameter, the representative is promoted, and the current career level is updated in the database 110 with the highest career level in step 128. Additionally, the representative's sponsor (i.e., another representative who brought the representative into the marketing plan) is placed in the representative queue for a possible promotion in step 130 if the representative is promoted, since the sponsor's downline has changed because of the representative's promotion.

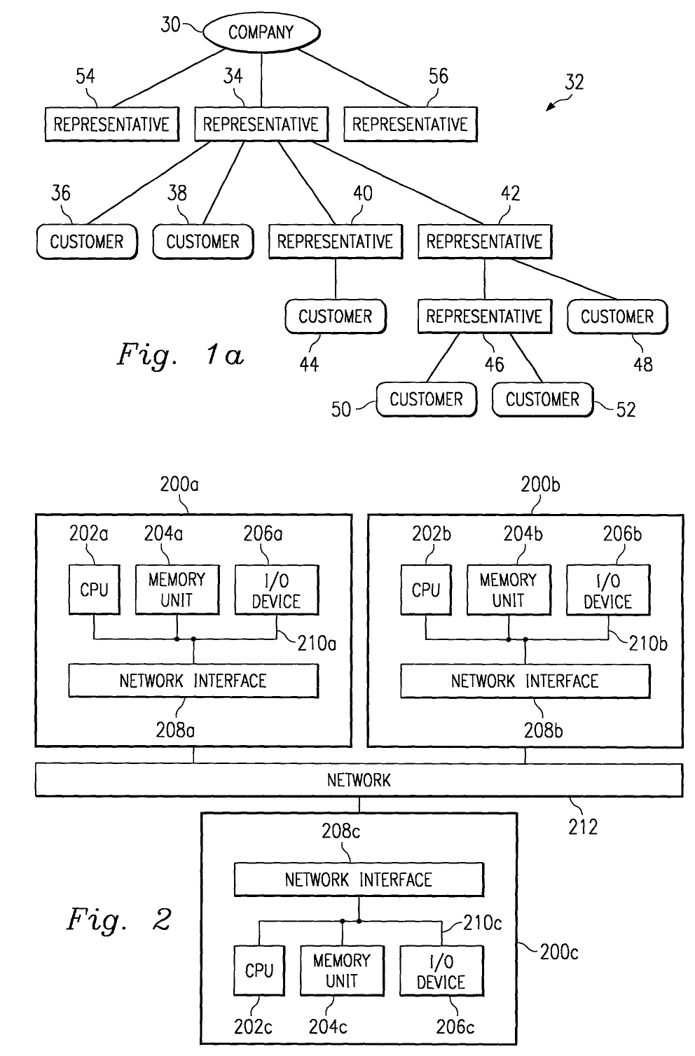

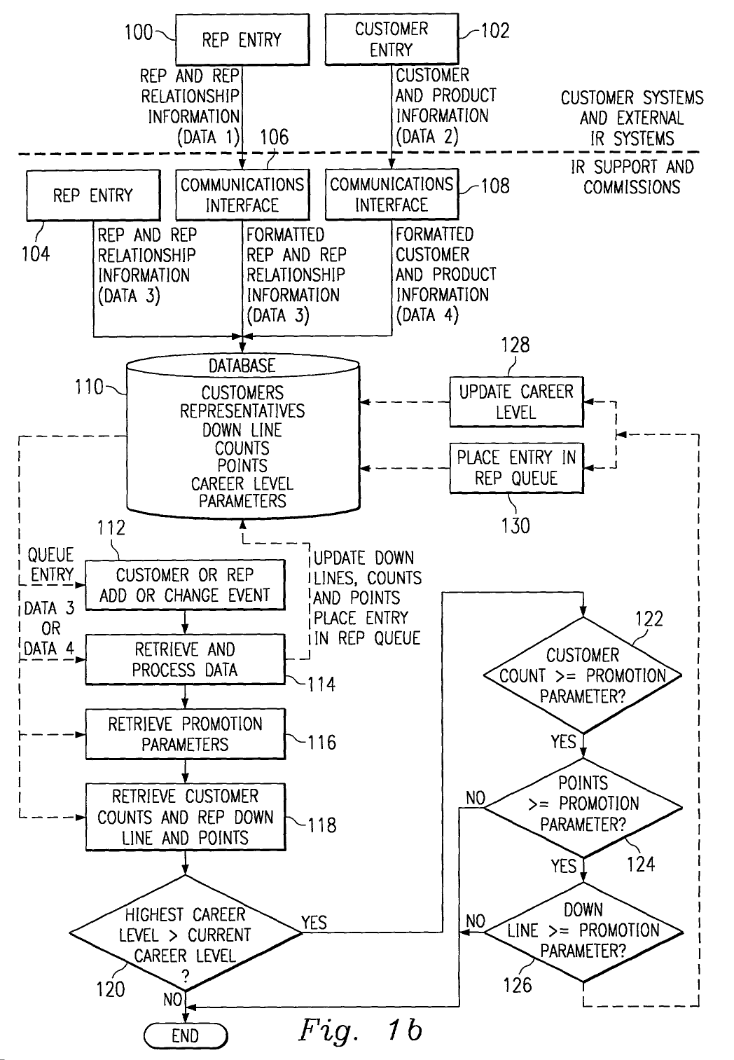

Referring now to FIG. 2, any number of computers may be used to create an operating environment for the marketing plan of FIG. 1a. For example, three computers, designated 200a, 200b, and 200c, represent one such environment. Each computer 200a, 200b, 200c includes a central processing unit (“CPU”) 202a, 202b, 202c, a memory unit 204a, 204b, 204c, an input/output (“I/O”) device 206a, 206b, 206c, and a network interface 208a, 208b, 208c, respectively. The components 202a, 204a, 206a, and 208a are interconnected by a bus system 210a, the components 202b, 204b, 206b, and 208b are interconnected by a bus system 210b, and the components 202c, 204c, 206c, and 208c are interconnected by a bus system 210c. It is understood that the computers may be differently configured and that each of the listed components may actually represent several different components. For example, the CPU 202a may actually represent a multi-processor or a distributed processing system; the memory unit 204b may include different levels of cache memory, main memory, hard disks, and remote storage locations; and the I/O device 206c may include monitors, keyboards, and the like.

The computers 200a, 200b, 200c are also commonly connected to a network 212. The network 212 may be representative of several networks, such as a local area network, a company wide intranet, and/or the Internet. Because the computers 200a, 200b, 200c are connected to the network 212, certain components may, at times, be shared between the computers. Therefore, a wide range of flexibility is anticipated in the configurations of the computers. Furthermore, it is understood that, in many implementations, the computers 200a, 200b, and 200c may be configured differently from each other, may have different components, and/or one computer may act as a server to the other computer.

Referring now to FIG. 3, the computers 200a, 200b, 200c and the network 212 of FIG. 2 are used to provide a marketing architecture 300. Software running on one or more of the computers 200a, 200b, 200c provide the different components of the architecture, which track changes relating to a representative, track client billing, and perform other functions. The software may be stored on a recordable medium, such as one or more of the memory units 204a, 204b, 204c, the network 212, or other medium.

The marketing architecture 300 includes a call center system 314, which may comprise the representative and customer entry systems 100-104 of FIG. 1b. The architecture 300 also includes a communications interface 316, which may comprise the communications interfaces 106, 108 of FIG. 1b. In addition, the architecture includes a first commissions system 318, a first database 320, such as the database 110 of FIG. 1b, a billing system 302, a financial system 304, a second commissions system 306, a second database 308, a representative status system 310, and a plurality of users 312.

The call center system 314 includes the customer and representative information for a specified area, such as a single country. The call center system 314 processes all incoming applications for customers and new representatives, as well as any application fees for new cross-border representatives and any initial data entry. Changes to a representative profile and changes in sponsorship, including promotions, cancellations, and terminations of representatives may also occur through the call center system 314. Information from the call center system 314 is transferred to the first commissions system 318 through the communications interface 316.

The billing system 302 includes capabilities for tracking customer usage and associated bills. For example, the billing system 302 may track the long distance telephone usage and billing of a customer who has purchased a long distance telephone calling plan from a representative.

The first commissions system 318, which may contain information for only a specified area, receives data from the call center system 314 and the billing system 302. It uses this data to calculate commissions, perform promotions, and establish information regarding such genealogy as the downline of each representative. In addition, the first commissions system 318 provides an end-user interface to view account information, issue adjustments to representatives if mistakes have been made regarding commissions or other payments, and retrieve and view commission information. An end user may also use the first commissions system 318 to manually promote a representative and enter commission adjustments. The first commissions system 318 may also produce outputs for a monthly downline statement and a check statement for a representative on each commission cycle. The monthly downline statement reports the representative's current downline, while the check statement itemizes each payment made to the representative and why the payment was made. The commission cycle is a defined period, such as one month, for which the representative receives payment.

The communications interface 316 is responsible for gathering and transferring information between the call center system 314, the billing system 302, and the first commissions system 318. The communications interface 12 handles all the information passing between the call center system 314 and the billing system 302, including new customer and representative information and changes, as well as the information between the call center system 314 and the first commissions system 318. The billing system 302 may pass some information directly to the first commissions system 318, such as customer information relating to a representative's downline.

The financial system 304 is responsible for the financial functions of recording commission payments in a general ledger and producing a print file for commission payments, both for check printing and electronic funds transfer. Any value added tax (“VAT”) computations are also included. After commission payments are calculated by the first commissions system 318, they are transferred to the financial system 304. The financial system 304 returns the gross check amount to the first commissions system 318 for inclusion on the check statement. Any adjustment made in the financial system 304, including VAT payment method and a payment identification number, is also returned to the first commissions system 318.

The second commissions system 306, which may contain information for a different geographic area than the first commissions system 318, receives a monthly feed of upline commission payouts for sponsoring representatives in its area. The file will contain the name of the cross-border representative, the representative's identification number, and the upline payment amount. The second commissions system 306 may calculate the eligibility of the upline and return payments destined for any ineligible representatives back to the first commissions system 318. The second commissions system 306 may also return promotion information on cross-border representatives to the first commissions system 318. In addition, the second commissions system 306 may calculate the eligibility for upline commissions triggered in the geographical area of the first commissions system 318.

The first database 320 includes information for the first commissions system 318, such as the career level, downline, and promotion parameters described in relation to FIG. 1a. The second database 308 may include information for the second commission system 306. The representative status system 310 allows representatives to retrieve status information regarding their account by telephone. Such information may include the number of customers, payments, and promotion information associated with the representative. Multiple users 312 may access representative information through interaction with the first commissions system 318.

Referring now to FIG. 4, an individual representative, such as the representative 40 of FIG. 1a, is represented by a representative object 400 in the marketing architecture of FIG. 3. This object representation enables the different components of the architecture to track and manipulate the representative's account and other relevant information. The representative 400 interacts with a number of other objects, including a downline 402, a customer 404, an adjustments 406, a payments 408, a promotions 410, a counts 412, an eligibility 414, a commissions 416, and a parameters 418. The different objects may be stored or manipulated by different components of the architecture, depending on the nature and requirements of each object.

The representative 400 represents an individual who has been recruited by another representative (e.g., the representative 34 of FIG. 1a) to obtain customers and new representatives. The representative 400 receives commissions in the form of back-end and front-end bonuses for gathering new customers and representatives, as well as commissions for the revenue generated by the customers. Related to the representative 400 is a sponsor (the representative 34), who may receive bonuses for the activity of the representative 400.

The downline 402 represents the organization of representatives and customers that are recruited by a sponsor, which in this case is the representative 400. Each of the representatives in the downline 402 may sponsor other representatives and build their own downline. A downline may be categorized as being either personal or organizational. For example, the personal downline of the representative 400 refers to the representatives recruited personally by the representative 400, while the organizational downline of the representative 400 refers to the personal downline of the representative 400, as well as those that the personal downline representatives recruited (i.e., the downlines of each representative in the personal downline of the representative 400).

The customer 404 produces revenue by subscribing to services and/or buying products from the company. This revenue is the basis for the back-end compensation received by the representative 400. In addition, the customer 404 also produces points, which the representative 400 needs for advancement. The points may represent the customer directly (for example, one point per customer) or the points may represent services purchased by the customer (for example, one point for basic telephone service and two points for long distance).

The representative 400 also interacts with the adjustments 406. The adjustments 406 are amounts entered into the commission system to correct a commission payment that was incorrectly calculated. Adjustment payments may be included in a subsequent commission cycle or through an immediate disbursement of funds.

The payments 408 are the compensation that the representative 400 receives. The payments 408 may be made by check, electronic funds transfer, or any other payment type that is designated by the representative 400. Regardless of the payment method, a statement itemizing the various activities which generated payment is mailed to the representative 400.

The promotions 410 represent the different promotional levels that may be attained by the representative 400. Advancing to the next level signifies that the representative 400 has achieved certain qualifications. The levels may include such titles as Independent Representative (“IR”), Qualified Representative (“QR”), Senior Representative (“SR”), Regional Director (“RD”), Executive Director (“ED”), Senior Director (“SD”), and Executive Senior Director (“ESD”). Each level may receive additional compensation, as well as other benefits. Upon reaching a level, the representative 400 may hold the title indefinitely, but should maintain certain minimum levels of performance to remain eligible for the commissions associated with that level. For example, the representative 400 may qualify for the title Regional Director, but must maintain a certain level of performance in order to earn the compensation at that level.

The counts 412 refer to the number of customers and downline representatives that the representative 400 has personally sponsored. The counts 412 are used in determining the eligibility for commission payments for the representative 400, as well as whether the representative 400 has qualified for the next promotional level.

The eligibility 414 represents the eligibility requirements that should be met before the representative 400 may receive commissions. Each of the promotional levels in the promotions 410 has certain qualifications that should be satisfied for the representative 400 to receive compensation for that level. If the representative 400 is ineligible, the representative 400 should receive compensation for the last promotional level for which the representative 400 was eligible. A grace period, such as one month each year, may be included in the eligibility calculations. This means that the representative 400 may be ineligible to receive the current level's commissions, but still receive them one time each year. If, after the grace period, the representative 400 is still ineligible, the representative 400 should receive the compensation of the level for which the representative 400 meets the eligibility requirements.

The commissions 416 include both front-end and back-end bonuses paid to the representative 400. These may be detailed in a compensation plan which explains various types of payments and how they may be earned by the representative 400.

The parameters 418 are the target goals which should be achieved by the representative 400 for payments and promotions. Such goals may include specified numbers of downline representatives and customers, as well as a minimum amount of revenue generated by those customers.

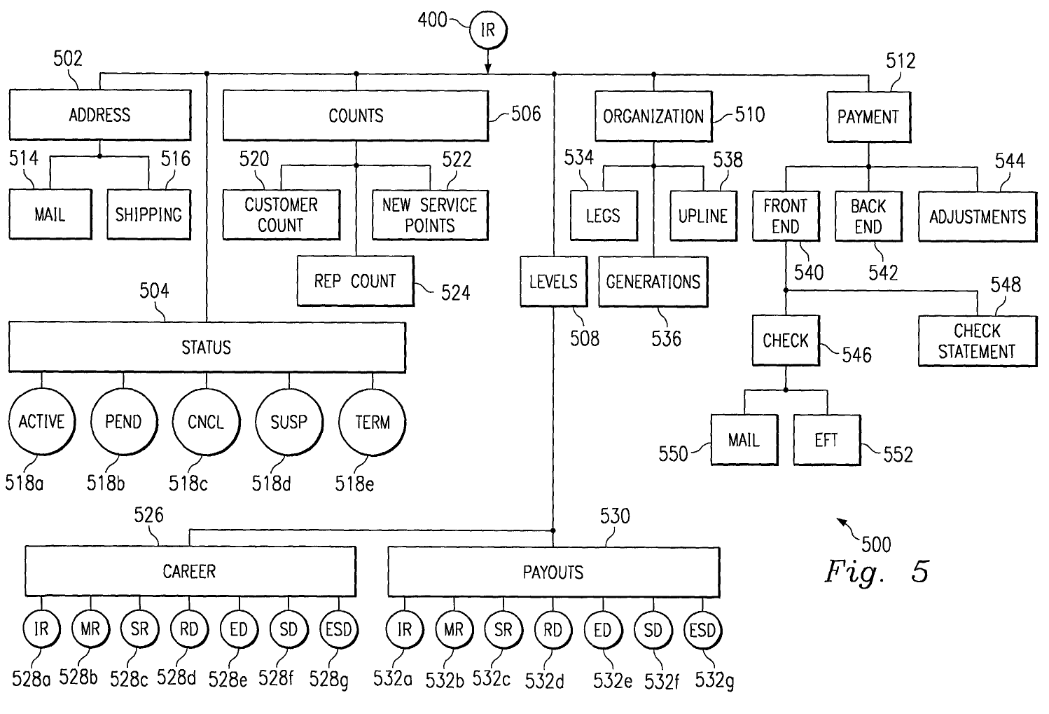

Referring now to FIG. 5, the representative 400 object may be further represented as a hierarchy of objects 500. Each object defines information specific to the representative 400 and may be manipulated to reflect changes in the representative 400's status and activities. The objects may be manipulated as part of either a Representative Engine or a backend/batch process (backend). The major objects under the representative 400 that are manipulated by the Representative Engine include an address 502, a status 504, a counts 506, and an organization 510. The other major objects under the representative 400 are a levels 508, which is manipulated partly by the Representative Engine and partly by the backend, and a payment 512, which is manipulated by the backend.

The address 502 includes the representative 400's mailing address 514 and shipping address 516. The status 504 may be divided into multiple status types 518a-518e, such as active, pending (“pend”), canceled (“cncl”), suspended (“susp”), and terminated (“term”). The payment of commissions is based partly on the status of the representative 400. In addition, a payment may be withheld for a specified amount of time depending on the status. Each status type 518a-518e may be further associated with multiple codes, with each code representing a reason for the representative 400 being represented by that particular status.

The counts 506 may include a customer count 520, a representative count 524, and new service points 522. The counts 506 may be used to determine whether the representative 400 is qualified and/or eligible to receive a commission.

The levels 508 may be further divided into a career level 526 (manipulated by the Representative Engine), which includes the promotion levels 528a-g, which are IR, QR, SR, RD, ED, SD, and ESD, respectively, and a payout level 530 (manipulated by the backend), which includes identical promotion levels 532a-g. The career level 526 represents the promotional level for which the representative 400 has qualified. The payout level 530 represents the eligibility level for which the representative 400 has qualified to receive commissions. Therefore, if the representative 400 has achieved the level RD in both the career and payout levels, the representative will be compensated as an RD.

The organization 510 refers to the representatives who are both upline and downline from the representative 400. This may be a fixed relationship that is established at the time the representative 400's account is created. The organization 510 includes legs 534, generations 536, and an upline 538. A leg 534 is a representative who is personally sponsored by the representative 400 and the downline below that representative. Each personally sponsored representative represents the top of a leg. A generation 536 is the first representative in a downline that has achieved a particular career level. For example, the first RD in a downline begins the upline's first RD generation. As stated previously, an upline 538 is the representative 400 and the organization directly above the representative 400.

The payment 512 is the compensation received by the representative 400. The payment 512 includes front-end bonuses 540, back-end bonuses 542, and manually entered adjustments 544. The representative 400 receives a check 546 for the front-end payment 540, and may choose whether the check 546 is received by mail 550 or by electronic funds transfer (“EFT”) 552. A check statement 548 itemizing the various activities which generated payment is mailed to the representative 400.

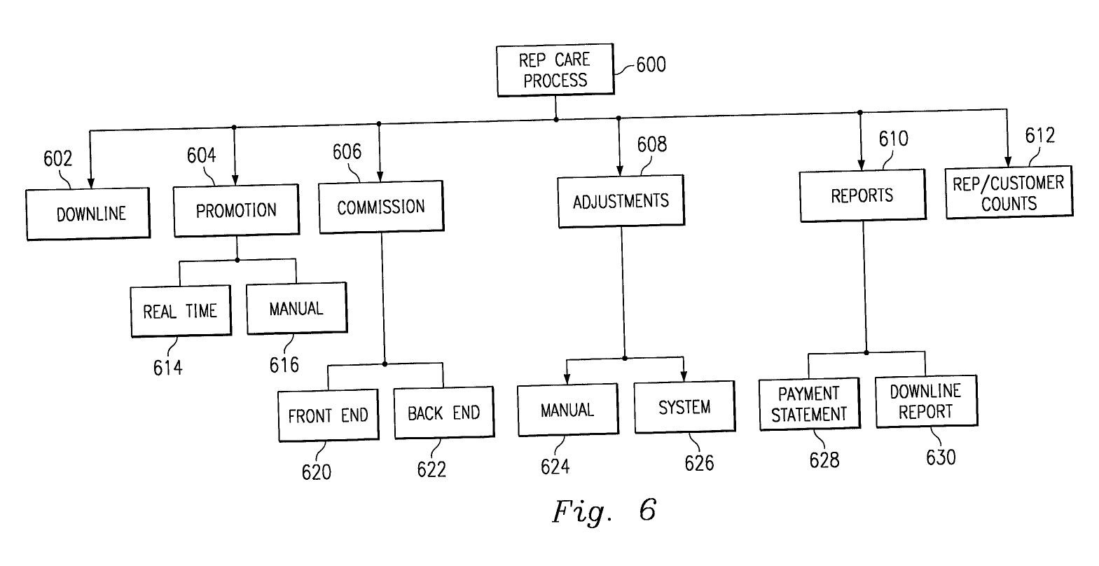

Referring now to FIG. 6, a representative care process 600 is utilized by the commissions systems of FIG. 3 to make changes to the information of a representative, such as the representative object representation illustrated in FIG. 5. The process 600 includes a number of other processes, each of which is capable of manipulating a specific aspect of the representative's information. A downline process 602 manipulates the downline of the representative, including adding or removing representatives and customers. It also determines genealogy by relating representatives and their sponsors. A promotion process 604 may be executed either automatically through a real time component 614 or through a manual component 616 to determine whether the representative has met the specified criteria for advancement in career level and to promote the representative if the criteria have been met. This process is described in further detail with respect to FIGS. 8-10. A commission process 606 may calculate payments for the representative based on the number of customers and representatives recruited, as well as the revenue generated by the customers. This includes both front-end bonuses 620 and back-end bonuses 622.

An adjustments process 608 allows the entering of adjustments for commissions that were miscalculated. This process may be executed automatically through the system 626 or manually 624. A reports process 610 produces and sends reports to the representative. Included is a monthly downline report 630 outlining the representative's current downline and a payment statement 628 specific to the commission cycle detailing the reason each commission was earned. A cutoff date may be included, and only the career level of the representative and the current counts at the cutoff date will be used for the report. A representative/customer counts process 612 uses representative and customer information from the call center system of FIG. 3 to provide qualification and eligibility information for the representative. The representative and customer information includes an identification number for each representative/customer to associate that customer with the proper representative.

A representative, represented in the marketing architecture using the relationships described above, receives promotions upon fulfilling certain eligibility requirements. Although the requirements may vary, they generally include such factors as a minimum number of representatives in the representative's downline, a minimum number of customers, and a minimum amount of revenue generated by the downline.

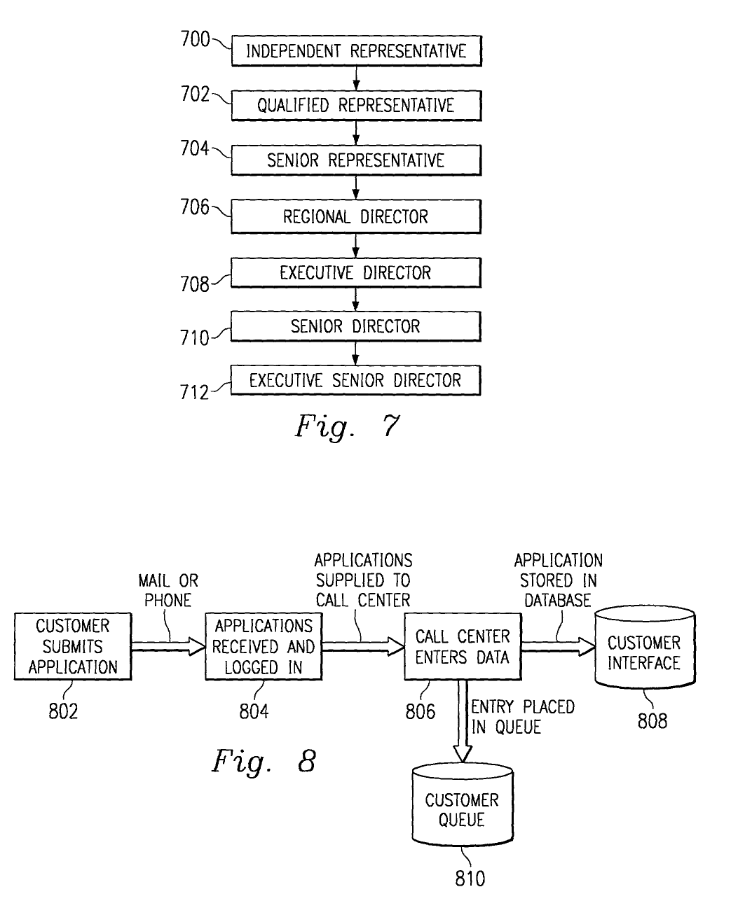

Referring now to FIG. 7, an illustrative promotional plan is used to describe a representative's promotion through the fulfillment of various promotional requirements. The promotion plan is described as one example, it being understood that a variety of promotion plan arrangements may be implemented consistent with the present disclosure. A new representative, such as the representative 34 of FIG. 1a, enters a company's marketing plan with the title IR in level 700. An IR is an independent contractor who sells the company's products and services to customers in return for compensation from the company. The representative's compensation is based on the amount of revenue generated by the representative's sales. An IR may be a Managing Representative (“MR”) or a Sales Representative (“Sales Rep”). An MR is an IR who enrolls in an optional management and training program offered by the company. The program is directed at training the IR to more effectively obtain customers and recruit other representatives. A Sales Rep is an IR that does not enroll in the program and so does not receive the extensive training of the MR. The MR and Sales Rep qualify for the same potential compensation.

The IR may receive additional compensation for other activities which benefit the company, such as training other representatives. For example, the IR may apply to become an Area Coordinator (“AC”), although an AC need not be an IR. An AC receives training from higher level representatives, and then receives compensation for training MRs. The representative may achieve more advanced training levels, such as a Regional Training Director (“RTD”) or a National Training Director (“NTD”).

An RTD is an IR/AC who has attained the position of Regional Director (discussed later), successfully completed the requirements of the Regional Training Director School, and been approved by the company. Alternatively, the RTD may be a non-IR AC who has been an AC in good standing for six months, successfully completed the requirements of the Regional Training Director School, and been approved by the company. An NTD is an IR/AC who has obtained the position of Executive Director (discussed later), successfully completed the requirements of the National Training Director School, and been approved by the company. Alternatively, the NTD may be a non-IR RTD who has been an RTD in good standing for nine months, successfully completed the requirements of the National Training Director School, and been approved by the company.

The IR's objective is to build a downline of customers and other representatives, which earns the IR additional compensation and the opportunity for promotion. To move to the next level 702 and earn the title of QR, the IR should personally sponsor three MRs and have 20 customer points. “Personally sponsor” means that the IR must have sponsored the MRs directly and not relied on MRs sponsored by another representative in the downline. For example, a downline MR who has sponsored two MRs does not allow the IR to claim three personally sponsored MRs. Customer points may be awarded for each customer who signs up or for different products and/or services. If the points are awarded for products or services, they may vary depending on the value of the product or service. For instance, if the IR is signing a up customer for a long distance telephone calling plan, a basic plan may earn only one customer point, while an extended plan with multiple options may earn two or more. Therefore, customer points allow the company to reward representatives who successfully market the services or products which the company wants to emphasize.

The representative, now a QR, continues to extend the downline by obtaining more customers and recruiting more representatives. The next promotional level is level 704 where the representative becomes an SR. To achieve this promotional level, the representative should have three personally sponsored MRs, one personally sponsored AC (which can be the representative), and ten customer points with $250 of customer usage. The customer usage requirement ensures that the company is earning revenue from the customers. For example, if the ten customer points represent ten customers who use the company's long distance telephone plan, they must generate a combined revenue of $250 per month for the company. This prevents a representative from signing up customers to earn promotions when the customers are not generating any revenue for the company.

To reach the position of RD in level 706, the representative should have previously achieved the SR position of level 704 and should personally sponsor three MRs and two ACs (one can be the representative). In addition, the representative needs twenty customer points with $500 of customer usage.

To become an ED in level 708, the representative should be an RD and personally sponsor two RDs and two RDs in downline levels 1-7. The requirement of two additional RDs in downline levels 1-7 ensures that the representative is actively developing the downline representatives, which earns the company more revenue. The representative should also have six personal ACs (one can be the representative) and twenty customer points with $500 of customer usage.

A title of SD, obtained in level 710, means that the representative has become an ED and personally sponsored four RDs. Becoming an SD also means that the representative has twenty customer points and $500 of customer usage.

To earn the title of ESD in level 712, the representative should be an SD and be personally sponsoring two SDs. The requirement of twenty customer points and $500 of customer usage also applies.

Each of the representative's promotions depends on tracking various factors of the representative's account, such as performance and downline. Maintaining and tracking the account manually is tedious and may result in inaccuracies. In addition, such manual tracking may increase the time required for the representative to receive a promotion, since each factor of the promotion has to be checked. Therefore, an automatic promotion process capable of checking the various factors described above and promoting the representative in real time when the factors are satisfied is desirable.

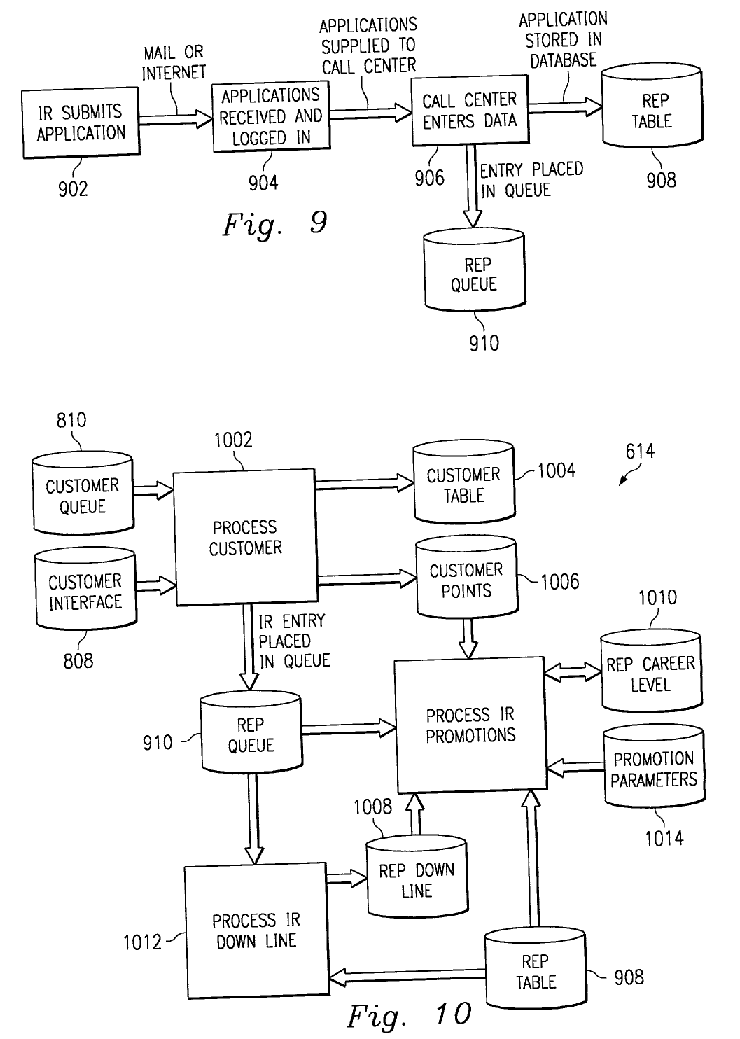

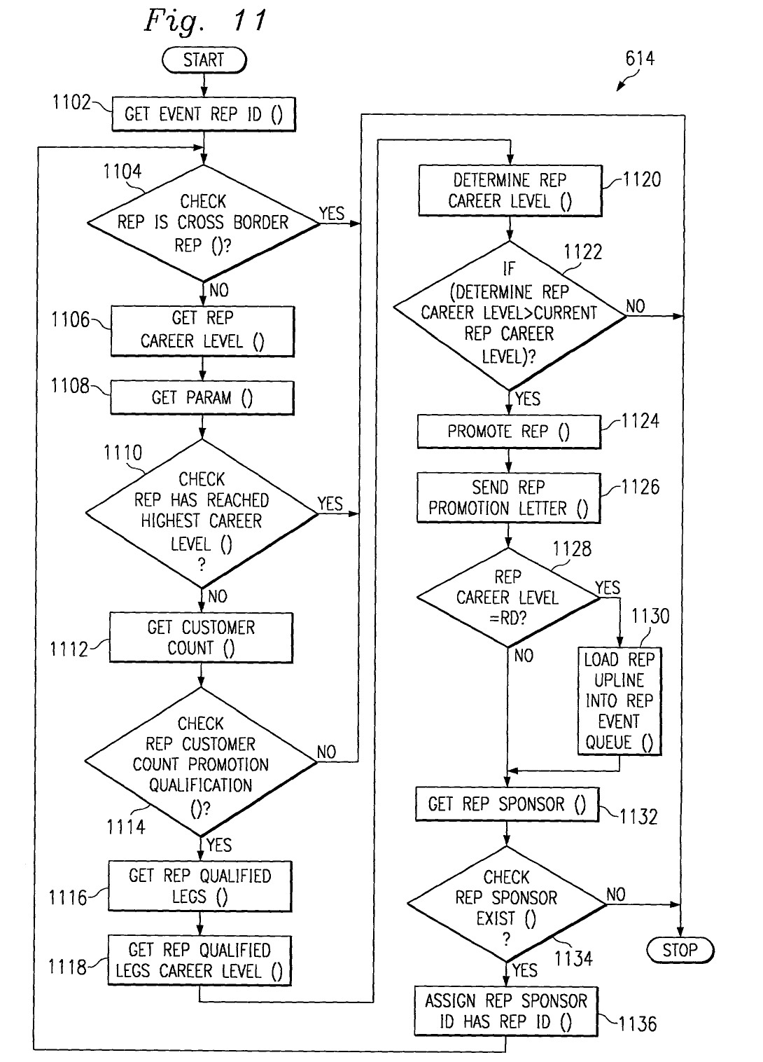

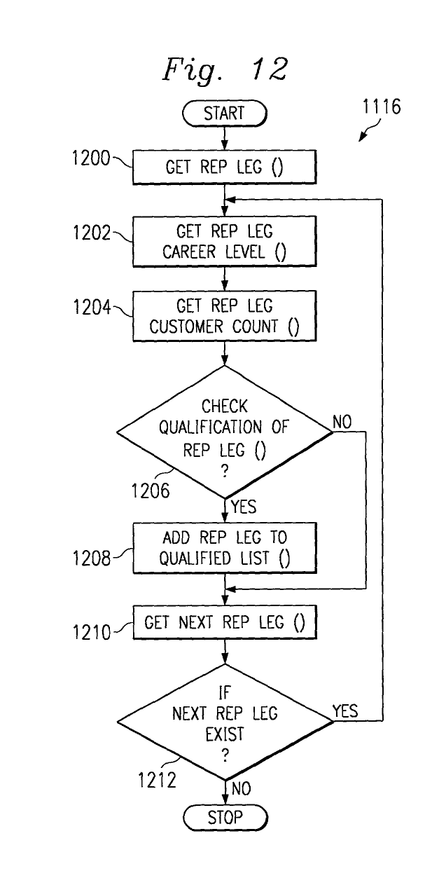

Referring now to FIGS. 8-10, the figures illustrate an exemplary flow of information through the system of FIG. 1 to enable the real time promotion process 614 of FIG. 6 to automatically promote a representative through the career levels illustrated in FIG. 7. FIGS. 8 and 9 illustrate the flow of information during the submission of a customer or representative application, while FIG. 10 illustrates the combination of the information flow provided in FIGS. 8 and 9 and the information flow in the promotion process. For purposes of clarity, a single database 20 serves as storage for the information in FIGS. 8-10. It is understood that the information may be located in multiple databases, on temporary storage devices, or on any combination of storage devices suitable for storing computer information.

Referring now specifically to FIG. 8, a customer may submit an application to become a customer or to obtain a product and/or service in step 802. In the present embodiment, the submission may occur by mail or phone, but other submission channels are also possible. In step 804, the application is received and logged in, after which it is passed on to a call center. The information represented by the application is entered by the call center in step 806 into a customer interface table 808 in the database 20. The entry is also placed in a customer queue 810. It is noted that the application may be formatted by a communications interface as illustrated in FIG. 1a. The customer information may include contact information for the customer, a customer account number, the product and/or service purchased by the customer, a status for the product or service, points for both the customer and product, a representative identification number to identify the representative associated with the customer, and similar information. Some fields may be blank, such as a company name, while other fields may need to be completed. More or less information may be in the customer record, depending on the desired level of detail. The customer information may be represented by a database record as illustrated in Table 1.

TABLE 1
Customer record

| Field | Value |
|---|---|
| CUST ACCOUNT NUM | GQ5L0C |
| REP ID | 1000077966 |
| FIRST NAME | IMA |
| LAST NAME | CUSTOMER |
| COMPANY NAME | |
| BTN | 2143515629 |
| ADDRESS | 3358 NOWHERE APT.110 |
| CITY | DALLAS |
| STATE | TX |
| POSTAL CODE | 77777 |
| SERVICE DATE | Mar. 26, 2001 |
| STATUS | ACTIVE |
| STATUS DATE | Mar. 26, 2001 |
| EXCOUNTRY | UNITED STATES |
| COUNTRY CODE | USA |
| POINT | 1 |
| PRODUCT CODE | 89 |
| CUST ACCOUNT NUM | GQ5L0C |
| PRODUCT START DATE | Mar. 26, 2001 |
| PRODUCT STATUS | ACTIVE |
| POINT | 1 |

Referring now to FIG. 9, a representative may submit an application for a new representative by mail or via the internet in step 902. As with the customer application of FIG. 8, other submission methods are possible. In step 904, the application is received and logged in before it is passed on to the call center. The call center enters the information represented by the application in step 906 and stores it in a representative interface table 908 in the database 20. The entry is also placed in a representative queue 910. It is noted that the application may be formatted by a communication interface as illustrated in FIG. 1.

The representative information may include a current status and contact information for the representative, a representative identification number, an identification number of the sponsoring representative, and similar information. Some fields may be blank, such as the company name, while other fields may need to be completed. More or less information may be in the representative record, depending on the desired level of detail. The representative information may be represented by a database record as illustrated in Table 2.

TABLE 2
Representative record

| Field | Value |
|---|---|
| REPID | 1000732122 |
| FIRST NAME | JOHN |
| LAST NAME | REPRESENTATIVE |
| COMPANY NAME | |
| STATUS | ACTIVE |
| SPONSOR | 1000077966 |
| ADDRESS | 5 ANYWHERE CT |
| CITY | RICHMOND |
| STATE | VA |
| POSTAL CODE | 22222 |

Referring now to FIG. 10, either the customer application of FIG. 8 or the representative application of FIG. 9 may trigger the promotion process 614 of FIG. 6 as follows. If the application was for a representative, the sponsoring representative is placed in the representative queue 910 as described in reference to FIG. 9. If the application was for a customer, the customer queue 810 and customer interface table 808 of FIG. 8 supply the information used to process the customer application in step 1002. After the customer application is processed, the representative associated with the application is placed in the representative queue 910, the customer is placed in a customer table 1004, and the customer points 1006 are stored. An exemplary database record of the customer points before and after the customer application is processed is illustrated in Tables 3 and 4, respectively. The customer count and point values have been arbitrarily selected for purposes of illustration.

TABLE 3
Original Count

| Field | Value |
|---|---|
| REPID | 1000077966 |
| CUST COUNT | 15 |
| CUST POINT | 19 |

TABLE 4
New Count

| Field | Value |
|---|---|
| REPID | 1000077966 |
| CUST COUNT | 16 |
| CUST POINT | 21 |

The promotions process retrieves a representative identification number from the representative queue 910. In the present embodiment, the identification number is retrieved from the queue 910 on a first-in-first-out basis, although other queuing methods may be used. Information relating to the representative is retrieved from the database. In the present embodiment, such information includes the customer count and points 1006 (illustrated above in Tables 3 and 4), the representative's downline 1008, and the current career level 1010. The representative's downline is processed in step 1012 to ensure that it is current, as illustrated by an exemplary database record in Tables 5 and 6. Tables 5 and 6 illustrate a promotion that occurs in the downline of the representative with the identification number 0077966. A representative with the identification number 1000732122 is promoted from an RD in the original downline illustrated in Table 5 to an ED in the updated downline illustrated in Table 6.

TABLE 5
Dowline before update
Original Downing

| | | | GENER- | |
|---|---|---|---|---|
| | | PARENT | ATION | |
| Field | REPID | REPID | LEVEL | CAREER LEVEL |
| Values | 1000108955 | 1000077966 | 1 | ED |
| | 1000732122 | 1000077966 | 1 | RD |
| | 1000606445 | 1000077966 | 1 | RD |
| | 1000140530 | 1000077966 | 1 | RD |

TABLE 6
Dowline after update
New Downline

| | | | GENER- | |
|---|---|---|---|---|
| | | PARENT | ATION | |
| Field | REPID | REPID | LEVEL | CAREER LEVEL |
| Values | 1000108955 | 1000077966 | 1 | ED |
| | 1000732122 | 1000077966 | 1 | ED |
| | 1000606445 | 1000077966 | 1 | RD |
| | 1000140530 | 1000077966 | 1 | RD |

After the promotions process 614 retrieves the representative's information from the database 20, the process retrieves the promotion parameters 1014 (illustrated as an exemplary database record in Table 7) and compares them with the representative's information to determine whether the representative qualifies for a promotion.

TABLE 7
Promotion Parameters

| Field | Values | | | | | |
|---|---|---|---|---|---|---|
| CAREER | QR | SR | RD | ED | SD | ESD |
| LEVEL | | | | | | |
| COUNTRY | USA | USA | USA | USA | USA | USA |
| CODE | | | | | | |
| REGION | NULL | NULL | NULL | NULL | NULL | NULL |
| STATE OF | NULL | NULL | NULL | NULL | NULL | NULL |
| PROVINCE | | | | | | |
| NUM OF | 0 | 0 | 0 | 0 | 0 | 0 |
| QUAL CUST | | | | | | |
| NUM OF | 0 | 3 | 6 | 4 | 4 | 2 |
| QUAL REP | | | | | | |
| NUM OF | 0 | 10 | 20 | 20 | 20 | 20 |
| QUAL CUST | | | | | | |
| POINTS | | | | | | |
| DOWN LINE | IR | IR | IR | RD | ED | SD |
| CAREER | | | | | | |
| LEVEL | | | | | | |
| DOWN LINE | 0 | 0 | 0 | 0 | 0 | 0 |
| QUAL CUST | | | | | | |
| DOWN LINE | 0 | 5 | 5 | 0 | 0 | 0 |
| QUAL | | | | | | |
| POINTS | | | | | | |
| NUM OF | 0 | 3 | 6 | 2 | 2 | 2 |
| DIRECT | | | | | | |
| QUAL IR | | | | | | |
| NUM OF | 0 | 0 | 0 | 2 | 0 | 0 |
| DOWN LINE | | | | | | |
| IR | | | | | | |

If the representative is eligible for a promotion, the promotion process 614 updates the representative's career level 1010 and places the representative's sponsor in the representative queue 910 to determine whether the sponsor is eligible for a promotion. Tables 8 and 9 illustrate an exemplary database record of the representative's career level before and after the representative is promoted from an ED to an SD.

TABLE 8
Career level before promotion
Before Promotion

| | CAREER | CURRENT | PROMOTION | PROMOTION |
|---|---|---|---|---|
| REPID | LEVEL | FLAG | DATE | STATUS |
| 1000077966 | ED | Y | Mar. 6, 1999 | ACTIVE |
| 1000077966 | RD | N | Sep. 25, 1995 | CLOSED |
| 1000077966 | MR | N | Feb. 28, 1994 | CLOSED |
| 1000077966 | SR | N | May 12, 1994 | CLOSED |

TABLE 9
Career level after promotion
After Promotion

| | CAREER | CURRENT | PROMOTION | PROMOTION |
|---|---|---|---|---|
| REPID | LEVEL | FLAG | DATE | STATUS |
| 1000077966 | SD | Y | Mar. 26, 2001 | ACTIVE |
| 1000077966 | ED | N | Mar. 6, 1999 | CLOSED |
| 1000077966 | RD | N | Sep. 25, 1995 | CLOSED |
| 1000077966 | QR | N | Feb. 28, 1994 | CLOSED |
| 1000077966 | SR | N | May 12, 1994 | CLOSED |

Referring now to FIG. 11, the real time promotion process illustrated in FIGS. 1, 10 and implemented as the real time promotion process 614 of FIG. 6 is operable to execute the promotions illustrated in FIG. 7. The process 614 utilizes the structure and system components described above to track and automatically promote a representative who meets the promotion parameters in real time.

The process 614 begins by retrieving a representative's identification information in step 1102. The process 614 then determines whether the representative is a cross-border representative in step 1104. A cross-border representative is one who operates across a geographic boundary, such as a country's border. If the representative is a cross-border representative, the process ends. However, if the representative is not, the process continues to step 1106, where the representative's career level is retrieved. In step 1108, the process retrieves promotion parameters. In step 1110, it is determined whether the representative has achieved the highest career level. If the representative is currently at the highest career level, the process ends. If the representative is not at the highest career level, the process continues to step 1112, where it retrieves the representative's customer count information. The process checks this information to determine if the representative is qualified for a promotion in step 1114. If the representative does not have qualify for a promotion on the basis of the customer points, the process ends. If the representative does have the minimum number of customer points for a promotion, the process continues to step 1116, where it retrieves the representative qualified legs as illustrated in FIG. 12.

Referring now to FIG. 12, the retrieval process of step 1116 of FIG. 11 begins when the process 614 retrieves the legs in step 1200, retrieves the representative leg career level in step 1202, and retrieves the representative leg customer count in step 1204. The process 614 then checks the representative leg qualification in 1206. If the representative leg qualifies, the process adds the leg to a representative leg qualification list in step 1208 and continues to 1210, where it retrieves the next representative leg. If the representative leg does not qualify, the process jumps directly to step 1210. If the next representative leg exists, as determined by the process in step 1212, the process returns to step 1202. Otherwise, the retrieval process of step 1116 ends.

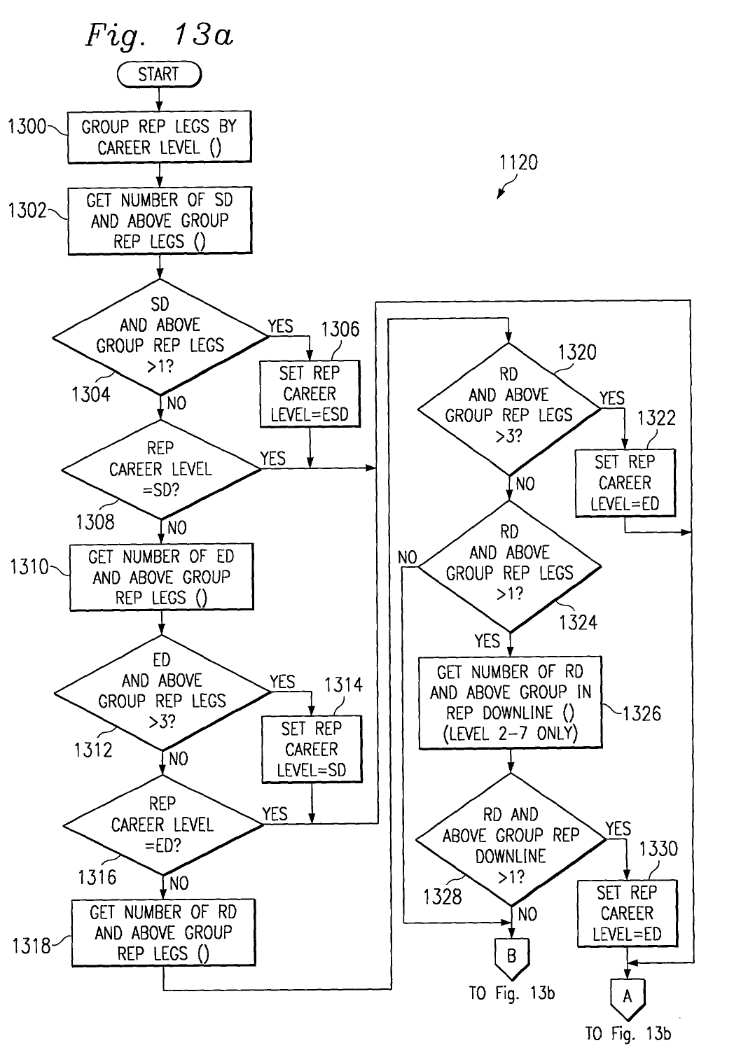

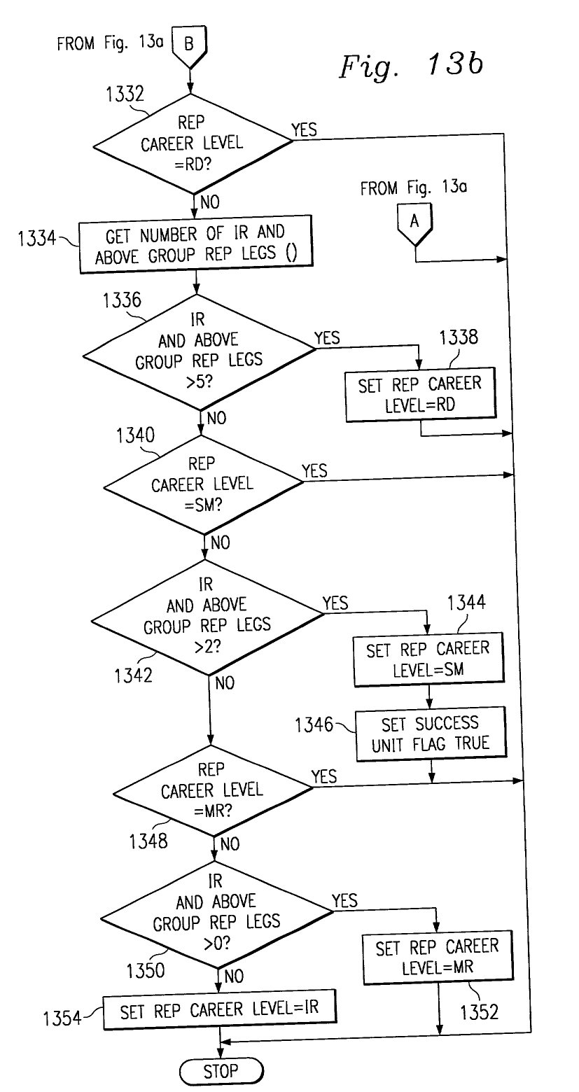

Referring again to FIG. 11, the process continues to step 1118, where it retrieves the representative qualified leg career level. In step 1120, the process 614 takes a number of steps to determine the career level of the representative, as illustrated in FIGS. 13a and 13b.

Referring now to FIG. 13a, in step 1300, the representative legs are grouped by their career level. In step 1302, the number of SD and above career level group representative legs is retrieved. If the number of SD and above group representative legs is greater than one as determined in step 1304, the process moves to step 1306, where it sets the career level to ESD and then stops. Otherwise, the process continues to step 1308, where it determines whether the representative's career level is SD. If it is, the process stops.

If the representative's career level is not SD, the process continues to step 1310, where it retrieves the number of ED and above career level group representative legs. If the number of ED and above group representative legs is greater than three as determined in step 1312, the process moves to step 1314, where it sets the career level to SD and then stops. Otherwise, the process continues to step 1316, where it determines whether the representative's career level is ED. If it is, the process stops.

Otherwise, the process continues to step 1318, where it retrieves the number of RD and above career level group representative legs. If the number of RD and above group representative legs is greater than three as determined in step 1320, the process moves to step 1322, where it sets the career level to ED and then stops.

If the number of RD and above group representative legs is not greater than three, the process moves to step 1324, where it determines if the number of RD and above group representative legs is greater than one. If yes, the process retrieves the number of RD and above career level groups in the representative downline levels 2-7 in step 1326 and proceeds to step 1328. If no, the process jumps to step 1332. In step 1328, if the number of RD and above group representative legs is determined to be greater than one, the process continues to step 1330, where it sets the representative's career level to ED and stops.

Referring now to FIG. 13b, if the number of RD and above group representative legs is determined in step 1324 to be greater than one, the process jumps to step 1332, where it determines if the representative's career level is RD. If yes, it stops. If no, the process proceeds to step 1334, where it retrieves the number of representative and above group representative legs. If the number of representative and above group representative legs is greater than five, as determined in step 1336, the process continues to step 1338. If not, it jumps to step 1340.

In step 1338, the process sets the representative career level to RD and stops. In step 1340, the process determines whether the representative's career level is SM. If it is, the process stops. If not, the process continues to step 1342, where it determines whether the number of representative and above group representative legs is greater than two. If yes, the process continues to step 1344, where it sets the representative's career level to SM and sets a success unit flag to “true” in step 1346 before stopping. The success unit flag represents the formation of a success unit, which includes ten qualified customer points, three personally sponsored MRs, and three MRs who in turn sponsor ten customer points. If the number of representative and above group representative legs is not greater than two, the process determines in step 1348 whether the representative's career level is MR and, if it is, the process stops. If not, the process moves to step 1350 and determines whether the number of representative and above group representative legs is greater than zero. If yes, the process moves to step 1352, where it sets the representative's career level to MR before stopping. If no, the process jumps to step 1354, where it sets the representative's career level to representative before stopping.

Referring again to FIG. 11, once the representative career level has been retrieved in step 1120, the process continues to step 1122, where it compares the career level determined in step 1118 with the current career level as retrieved in step 1120. If the determined career level is not greater than the current career level, the process stops. If it is, the process proceeds to step 1124, where the representative is promoted to the next career level. The process then proceeds to step 1126, where a letter informing the representative of the promotion is sent to the representative. Moving to step 1128, the process determines whether the representative's career level is RD. If yes, the process loads the representative's upline into the representative event queue in step 1130 before moving to step 1132. If no, the process jumps directly to step 1132. In step 1132, the process retrieves the representative sponsor's ID and proceeds to step 1134, where it checks whether the sponsor's representative ID exists. If no, the process stops. If yes, the process assigns the sponsor's representative ID to the IR ID in step 1136 before returning to step 1104 to determine if a promotion should occur.

While the invention has been particularly shown and described with reference to the preferred embodiments thereof, it will be understood by those skilled in the art that various changes in form and detail may be made therein without departing form the spirit and scope of the invention, as set forth in the following claims.

What is claimed is:

1. A system for automatically promoting a representative in a marketing plan with a plurality of career levels, the representative associated with account information including a current career level and a downline, the system comprising:
a representative entry system;
a communications interface accessible to the representative entry system;
a database accessible to the representative entry system through the communications interface, the database including the current career level, the downline, and a plurality of promotion parameters defining at least one qualification necessary for promotion to each of the plurality of career levels;
software operable to interact with the database and comprising instructions for:
applying a first promotion parameter to the account information to identify a highest career level for which the representative is qualified;
comparing the highest career level to the current career level of the representative;
comparing the downline to a second promotion parameter; and
automatically promoting the representative if the highest career level is greater than the current career level and the downline satisfies the second promotion parameter.

2. The system of claim 1 wherein the software further comprises instructions for:
accepting application information for a second representative, the second representative being associated with the first representative;
updating the account information to reflect the application information;
entering the first representative in a queue, the entry notifying the system that the first representative may qualify for a promotion;
dequeueing the first representative from the queue according to a predetermined sequence;
retrieving the plurality of promotion parameters from the database;
retrieving the updated account information from the database; and
updating the current career level in the database with the highest career level if a promotion occurs.

3. The system of claim 1 further including:
a customer entry system; and
a second communications interface accessible to the customer entry system;
wherein the database is accessible to the customer entry system through the second communications interface.

4. The system of claim 3 wherein the software further includes instructions for:
retrieving a customer count associated with the account information; and
comparing the customer count to a third promotion parameter;
wherein the representative is not promoted unless the customer count satisfies the third promotion parameter.

5. The system of claim 4 wherein the software further includes instructions for:
retrieving at least one customer point associated with the account information; and
comparing the at least one customer point to a fourth promotion parameter;
wherein the representative is not promoted unless the at least one customer point satisfies the fourth promotion parameter.

6. The system of claim 1 further including a second representative entry system, the database being accessible to the second representative entry system without a communications interface.

7. The system of claim 1 wherein the first representative is sponsored by a second representative, and the second representative is placed in the queue if the first representative receives a promotion.

8. The system of claim 1 further including a call center, the call center operable to receive an application for a representative and enter the application into the database.

9. The system of claim 8 wherein the call center is further operable to receive an application for a customer and enter the application into the database.

10. The system of claim 1 wherein the software further includes instructions for notifying the representative of the promotion.

11. A system for promoting in real time a representative in a marketing plan with a plurality of career levels, the representative associated with account information including a relational hierarchy comprising a plurality of representatives and customers, the system comprising:
an application entry system;
a database accessible to the application entry system, the database including the account information and a plurality of promotion parameters defining at least one qualification necessary for promotion to each of the plurality of career levels;
software, operable to interact with the database, the software comprising instructions for:
accepting application information for an addition to the hierarchy through the application entry system;
updating the account information to reflect the application information;
entering the representative in a queue, the entry notifying the system that the representative may qualify for a promotion;
dequeueing the representative from the queue;
retrieving the plurality of promotion parameters from the database;
retrieving the updated account information from the database;
applying the promotion parameters to the account information to determine if the representative qualifies for a promotion; and
promoting the representative in real time if the account information satisfies the promotion parameters.

12. The system of claim 11 wherein the account information includes a career level which must satisfy at least one of the promotion parameters before the representative is promoted.

13. The system of claim 11 wherein the account information includes a downline which must satisfy at least one of the promotion parameters before the representative is promoted.

14. The system of claim 11 wherein the software further includes instructions for notifying the representative of the promotion.

15. The system of claim 11 wherein the first representative is sponsored by a third representative, and the third representative is placed in the queue if the first representative receives a promotion.

16. A method for automatically promoting a first representative in a marketing plan with a plurality of career levels, the first representative associated with account information including a current career level and a downline, the method comprising:
identifying the first representative for a possible promotion if a second representative associated with the first representative joins the marketing plan;
applying a first promotion parameter to the account information to identify a highest career level for which the first representative is qualified;
comparing the highest career level to the current career level of the first representative;
comparing the downline to a second promotion parameter;
automatically promoting the representative if the highest career level is greater than the current career level and the downline satisfies the second promotion parameter; and
replacing the current career level with the highest career level if a promotion occurs.

17. The method of claim 16 further including:
retrieving a customer count associated with the account information; and
comparing the customer count to a third promotion parameter;
wherein the representative is not promoted unless the customer count satisfies the third promotion parameter.

18. The method of claim 16 further including:
retrieving at least one customer point associated with the account information; and
comparing the at least one customer point to a fourth promotion parameter;
wherein the representative is not promoted unless the at least one customer point satisfies the fourth promotion parameter.

19. The method of claim 16 further including identifying the first representative for a possible promotion if a customer associated with the first representative joins the marketing plan.

20. The method of claim 19 wherein the customer joins the marketing plan by purchasing either a service or a product.

21. The method of claim 16 wherein a plurality of representatives are identified for a plurality of promotions.

22. The method of claim 21 wherein the plurality of representatives are enqueued and dequeued in a first-in-first-out order, wherein the account information of the dequeued representative is compared to the plurality of promotion parameters to determine whether the dequeued representative qualifies for a promotion.

23. A method for promoting in real time a representative in a marketing plan with a plurality of career levels, the representative associated with account information including a relational hierarchy comprising a plurality of representatives and customers, the method comprising:
accepting application information for an addition to the hierarchy;
updating the account information to reflect the application information;
notifying the system that the representative may qualify for a promotion;
applying a plurality of promotion parameters to the account information to determine if the first representative qualifies for a promotion; and
promoting the representative in real time if the account information satisfies the promotion parameters.

24. The method of claim 23 wherein the relational hierarchy includes a sponsoring representative, wherein the promotion of the representative notifies the system that the sponsoring representative may qualify for a promotion.

25. The method of claim 23 wherein the account information includes a career level which must satisfy at least one of the promotion parameters before the representative is promoted.

26. The method of claim 23 wherein the account information includes a downline which must satisfy at least one of the promotion parameters before the representative is promoted.

27. The method of claim 23 wherein the software further includes instructions for notifying the representative of the promotion.
